(19) United States
(12) Patent Application Publication
(10) Pub. No.: US 2024/0140310 A1
(43) Pub. Date: May 2, 2024

(54) VEHICLE

(71) Applicant: TOYOTA JIDOSHA KABUSHIKI KAISHA, Toyota-shi (JP)

(72) Inventors: Masaaki SATO, Susono-shi (JP); Takeru SHIRASAWA, Shizuoka-ken (JP); Teruaki HAIBARA, Toyota-shi (JP); Kenji HOSHI, Gotemba-shi (JP)

(73) Assignee: TOYOTA JIDOSHA KABUSHIKI KAISHA, Toyota-shi (JP)

(21) Appl. No.: 18/379,212

(22) Filed: Oct. 12, 2023

(30) Foreign Application Priority Data
Oct. 31, 2022 (JP) 2022-174430

(51) Int. Cl. B60R 1/22; B60W 30/06; E05F 15/73; H04N 7/18

(52) U.S. Cl. CPC B60R 1/22; B60W 30/06; E05F 15/73; H04N 7/181; G06V 20/586

(57) ABSTRACT

A vehicle may include a camera configured to capture surroundings around the vehicle; a receiver; a display device; and a controller configured to display an image that the camera is currently capturing on the display device with reception of a signal transmitted from a vehicle washer by the receiver as a trigger.

### CROSS-REFERENCE TO RELATED APPLICATION

This application claims priority from Japanese Patent Application No. 2022-174430 filed on Oct. 31, 2022. The entire content of the priority application is incorporated herein by reference.

### BACKGROUND ART

The technique disclosed herein relates to a vehicle.

Japanese Patent Application Publication No. 2017-074817 describes a vehicle washer. A vehicle can be washed by activating the vehicle washer after the vehicle is parked in a parking space of the vehicle washer.

### SUMMARY

To park a vehicle in a parking space of a vehicle washer, the vehicle needs to be moved closer to the vehicle washer. This may make the driver feel psychologically stressed (especially if the driver is less experienced). The disclosure herein proposes a technique of allowing a vehicle to be parked in a parking space of a vehicle washer while perceiving a positional relationship between the vehicle and the vehicle washer.

A vehicle of item 1 disclosed herein may comprise a camera configured to capture surroundings around the vehicle, a receiver, a display device, and a controller configured to display an image that the camera is currently capturing on the display device with reception of a signal transmitted from a vehicle washer by the receiver as a trigger.

In this vehicle, the receiver receives the signal transmitted from the vehicle washer as the vehicle approaches the vehicle washer. Then, with the reception of the signal as a trigger, the controller displays an image the camera is currently capturing on the display device. That is, the image around the vehicle is displayed on the display device. Thus, the driver can park the vehicle in a parking space of the vehicle washer while perceiving the positional relationship between the vehicle and the vehicle washer from the image displayed on the display device.

### BRIEF DESCRIPTION OF THE DRAWINGS

FIG. 1 is a perspective view of a vehicle and a vehicle washer.

FIG. 2 is a block diagram of the vehicle.

FIG. 3 is a flowchart showing a process of vehicle washing.

FIG. 4 is a diagram showing an example of a panoramic display.

### DETAILED DESCRIPTION OF EMBODIMENTS

Hereinafter, following the above-mentioned item 1, configurations of the technique disclosed herein will be described item by item.

(Item 2) The vehicle of item 1, wherein the controller is configured to automatically display the image on the display device when the receiver receives the signal transmitted from the vehicle washer.

(Item 3) The vehicle of item 1, wherein the controller is configured to notify a driver that the image is to be displayed when the receiver receives the signal transmitted from the vehicle washer, and display the image on the display device when the driver performs a predetermined operation in response to the notification.

(Item 4) The vehicle of any one of items 1 to 3, wherein the controller is configured to perform a process of parking the vehicle in a parking space of the vehicle washer by automatic driving while displaying the image on the display device.

(Item 5) The vehicle of any one of items 1 to 4, further comprising a window that is openable and a door mirror that is foldable, wherein the controller is configured to perform a process of closing the window and folding the door mirror when the receiver receives the signal.

According to the configuration of the above item 4, the driver can verify the surroundings around the vehicle from the image displayed on the display device during the automatic driving.

According to the configuration of the above item 5, preparation for vehicle washing can be facilitated.

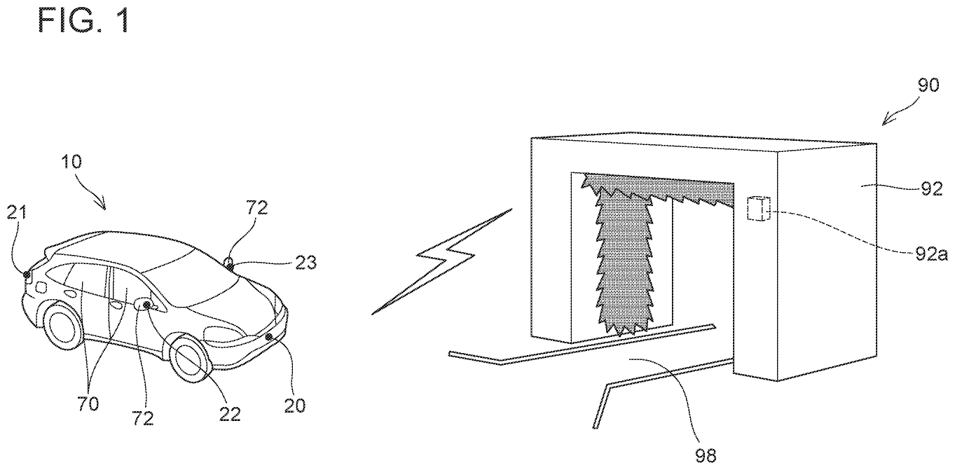

FIG. 1 shows a vehicle 10 of an embodiment. The vehicle 10 may be an engine-driven vehicle or an electric vehicle. FIG. 1 also shows a vehicle washer 90. The vehicle washer 90 comprises a main body 92. The main body 92 has a gate-like shape that surrounds top and lateral portions of a parking space 98. By parking the vehicle 10 in the parking space 98 and then activating the vehicle washer 90, the vehicle 10 can be washed by the vehicle washer 90. The main body 92 comprises a control unit 92a. The control unit 92a comprises a radio communication device. The control unit 92a can communicate with the vehicle 10. The vehicle washer 90 comprises a plurality of vehicle sensors configured to detect a vehicle around the parking space 98, although this is not shown. Each of the vehicle sensors is connected to the control unit 92a via a communication line.

As illustrated in FIG. 1, the vehicle 10 comprises a front camera 20, a rear camera 21, a right side camera 22, and a left side camera 23. The cameras 20 to 23 capture images of the surroundings around the vehicle 10. That is, the front camera 20 captures images of the surroundings ahead of the vehicle 10. The rear camera 21 captures images of the surroundings behind the vehicle 10. The right side camera 22 captures images of the surroundings on the right side of the vehicle 10. The left side camera 23 captures images of the surroundings on the left side of the vehicle 10.

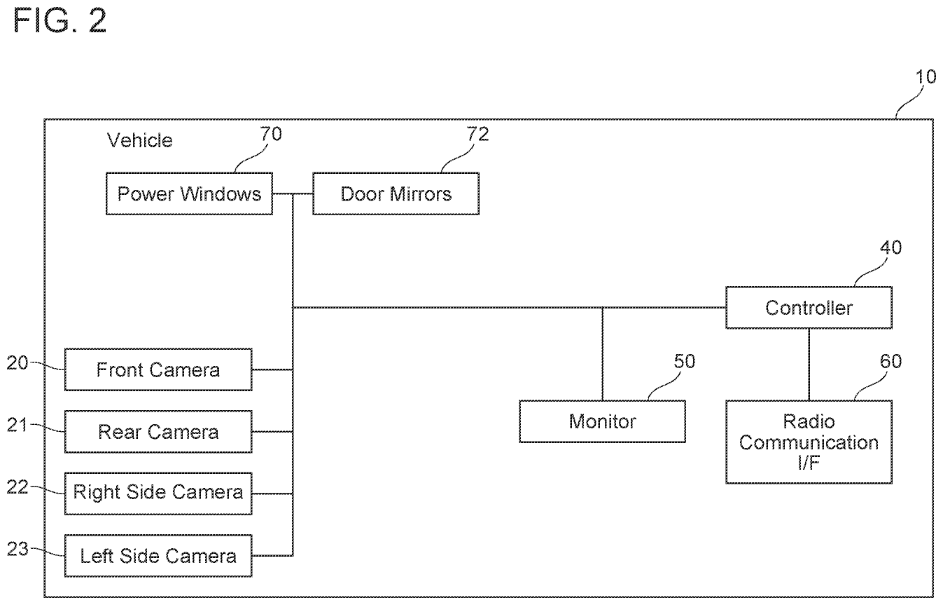

FIG. 2 shows devices mounted on the vehicle 10. As shown in FIG. 2, the vehicle 10 comprises a controller 40. The controller 40 includes a CPU, RAM, ROM, etc. In FIG. 2, the controller 40 is indicated by a single block, however, the controller 40 may be configured by a plurality of ECUs (Electric Control Units) dispersedly arranged inside the vehicle 10. The cameras 20 to 23 are connected to the controller 40 via communication lines such as communication buses. Each of the cameras 20 to 23 captures an image at a predetermined cycle and transmits it to the controller 40.

The vehicle 10 comprises a monitor 50 (i.e., a display device). The monitor 50 may be a monitor of a car navigation device or a monitor provided separately from a car navigation device. The monitor 50 is connected to the controller 40 via a communication line. The controller 40 is configured to combine images captured by the cameras 20 to 23 to generate an image that shows the surroundings all around the vehicle 10 (hereinafter, this image will be referred to as a panoramic image), and display the generated panoramic image on the monitor 50. That is, the controller 40 can display the surroundings of the vehicle 10 in real time on the monitor 50 by a so-called panoramic display.

The vehicle 10 comprises a radio communication interface 60. The radio communication interface 60 is connected to the controller 40 via a communication line. The controller 40 can communicate with the control unit 92a of the vehicle washer 90 via the radio communication interface 60.

The vehicle 10 comprises power windows 70 and door mirrors 72. The power windows 70 and the door mirrors 72 are connected to the controller 40 via communication lines. The controller 40 can open and close the power windows 70. The controller 40 can also fold and unfold the door mirrors 72.

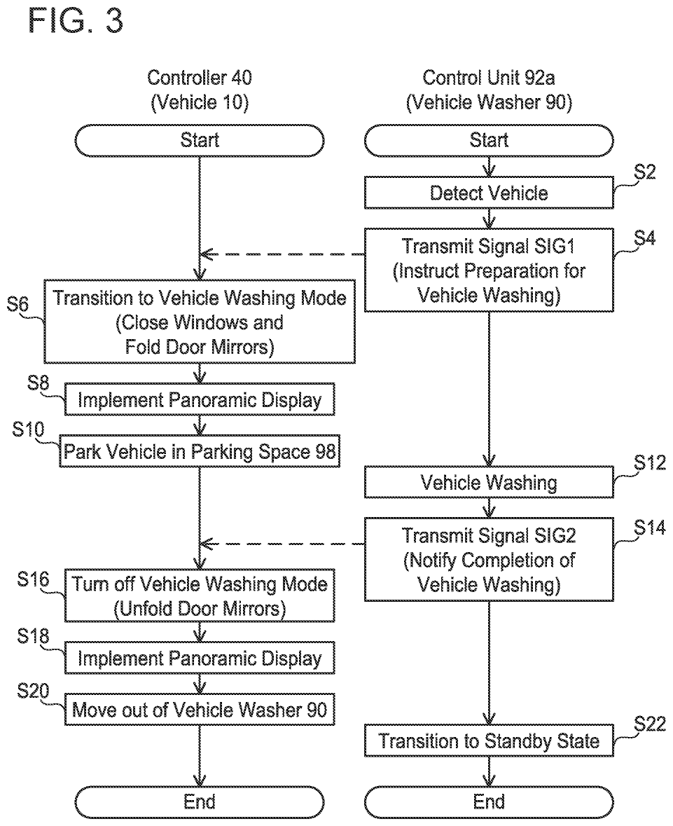

Next, how the vehicle 10 operates when the vehicle 10 is to be parked in the parking space 98 of the vehicle washer 90 will be described with reference to FIG. 3.

As the vehicle 10 approaches the entrance of the vehicle washer 90, the vehicle washer 90 detects the vehicle 10 by the vehicle sensors (not shown) in step S2 of FIG. 3. Then, in step S4, the control unit 92a transmits, to the controller 40 of the vehicle 10, a signal SIG1 that instructs preparation for vehicle washing.

The controller 40 of the vehicle 10, when receiving the signal SIG1, causes the vehicle 10 to transition to a vehicle washing mode in step S6. The vehicle washing mode is a mode of the vehicle 10 that is suitable for washing by a vehicle washer. More specifically, in step S6, the controller 40 closes all the power windows 70. This prevents washing water from entering the interior of the vehicle 10 in the subsequent vehicle washing. In addition, in step S6, the controller 40 folds the left and right door mirrors 72. Also, in step S6, the controller 40 transitions to a mode in which an air conditioner and audio instruments are usable even in an ignition-off state. Therefore, during the subsequent vehicle washing, the driver can use the air conditioner and the audio instruments even in the ignition-off state.

The controller 40 then implements the panoramic display in step S8. That is, the controller 40 displays the panoramic image generated by combining images captured by the cameras 20 to 23 on the monitor 50.

The controller 40 may implement the panoramic display in any manner so long as it implements the panoramic display of step S8 with the reception of the signal SIG1 as a trigger. For example, the controller 40 may automatically implement the panoramic display upon the reception of the signal SIG1. In this case, the panoramic display is implemented without an operation by the driver. Alternatively, the controller 40 may display on the monitor 50 a message that notifies that the panoramic display is to be implemented upon the reception of the signal SIG1, and implement the panoramic display when the driver performs a predetermined operation in response to the message. For example, the controller 40 may display on the monitor 50 a message that verifies whether the panoramic display should be implemented or not upon the reception of the signal SIG1 and implement the panoramic display when the driver selects “YES” on the monitor 50.

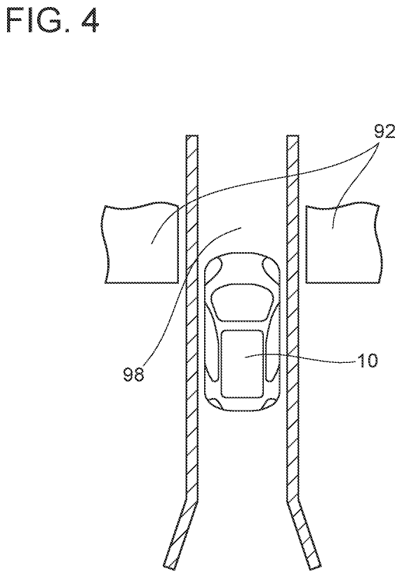

When steps S6, S8 are completed, the controller 40 instructs the driver to move the vehicle 10 toward/into the parking space 98 through auditory and/or visual instructions. The driver then drives to move the vehicle 10 toward/into the parking space 98 in step S10. Since the panoramic display is being implemented on the monitor 50, the driver can move the vehicle 10 toward/into the parking space 98 while perceiving the positional relationship between the vehicle and the vehicle washer. For example, as the vehicle 10 approaches the main body 92 of the vehicle washer 90, the main body 92 is displayed in the panoramic image, as shown in FIG. 4. Thus, the driver can park the vehicle 10 in the parking space 98 while perceiving the positional relationship between the vehicle 10 and the main body 92. During the panoramic display, an audio guidance related to driving may be given to the driver. For example, if the vehicle 10 is close to the main body 92 on the right side, a voice guidance saying such as “too close on the right side” may be given.

Once the vehicle 10 is parked in the parking space 98, the vehicle washer 90 detects the parking of the vehicle 10 by the vehicle sensors (not shown). Then, in step S12, the control unit 92a causes the vehicle washer 90 to perform vehicle washing. During the vehicle washing, the ignition is off, and thus the panoramic display is stopped. When the vehicle washing is completed, the control unit 92a transmits a signal SIG2 that notifies the completion of the vehicle washing to the controller 40 of the vehicle 10 in step S14.

When receiving the signal SIG2, the controller 40 turns off the vehicle washing mode in step S16. More specifically, in step S16, the controller 40 unfolds the left and right door mirrors 72. Also, in step S16, the controller 40 transitions to a mode in which the air conditioner and the audio instruments are unusable in the ignition-off state.

Next, in step S18, the controller 40 implements the panoramic display. As in step S8, the controller 40 may implement the panoramic display in any manner in step S18 as well, so long as it implements the panoramic display with the reception of the signal SIG2 as a trigger.

Next, in step S20, the driver moves the vehicle 10 out of the vehicle washer 90. Since the panoramic display is being implemented, the driver can move the vehicle 10 out of the vehicle washer 90 while perceiving the positional relationship between the vehicle 10 and the vehicle washer 90. Thereafter, the controller 40 terminates the panoramic display at an appropriate timing. Further, once the vehicle 10 moves out of the vehicle washer 90, the vehicle washer 90 detects the movement of the vehicle 10 by the vehicle sensors (not shown) and transitions to a standby state in step S22.

As described above, the vehicle 10 implements the panoramic display when moving toward/into the parking space 98 of the vehicle washer 90. Thus, the driver can easily park the vehicle 10 in the parking space 98 of the vehicle washer 90. In addition, the transition to the vehicle washing mode is implemented along with the panoramic display, and preparation for the vehicle washing is facilitated.

The vehicle 10 may have an automatic parking function. In the vehicle 10 having the automatic parking function, the controller 40 recognizes a parking space from images captured by the cameras and controls a transmission, a prime mover (i.e., an engine or a motor), a brake, a steering, etc. to park the vehicle 10 in the parking space. With the vehicle 10 having the automatic parking function, the parking in step S10 may be implemented by the automatic parking function instead of the driving by the driver. Even when the vehicle is parked in the parking space 98 of the vehicle washer 90 by the automatic parking function as described above, the driver can monitor the positional relationship between the vehicle 10 and the main body 92 while the vehicle 10 is moving owing to the panoramic display. If the vehicle is parked by the automatic parking function in step S10, a signal that notifies the completion of parking may be transmitted from the controller 40 of the vehicle 10 to the control unit 92a of the vehicle washer 90 when the parking is completed. In this case, the control unit 92a of the vehicle washer 90 may cause the vehicle washer 90 to start the vehicle washing in step S12 after receiving the signal.

In the embodiment described above, the panoramic image is displayed on the monitor 50, however, the image displayed on the monitor 50 in step S8 may be any image so long as the positional relationship between the vehicle 10 and the vehicle washer 90 can be perceived from it. For example, only an image of the surroundings ahead of the vehicle 10 (e.g., an image currently being captured by the front camera 20) may be displayed on the monitor 50. Alternatively, both the panoramic image and the image of the surroundings ahead of the vehicle 10 may be displayed on the monitor 50.

The embodiments have been described in detail in the above. However, these are only examples and do not limit the claims. The technology described in the claims includes various modifications and changes of the concrete examples represented above. The technical elements explained in the present description or drawings exert technical utility independently or in combination of some of them, and the combination is not limited to one described in the claims as filed. Moreover, the technology exemplified in the present description or drawings achieves a plurality of objects at the same time, and has technical utility by achieving one of such objects.

What is claimed is:

1. A vehicle comprising:
a camera configured to capture surroundings around the vehicle;
a receiver;
a display device; and
a controller configured to display an image that the camera is currently capturing on the display device with reception of a signal transmitted from a vehicle washer by the receiver as a trigger.

2. The vehicle of claim 1, wherein the controller is configured to automatically display the image on the display device when the receiver receives the signal transmitted from the vehicle washer.

3. The vehicle of claim 1, wherein the controller is configured to notify a driver that the image is to be displayed when the receiver receives the signal transmitted from the vehicle washer, and display the image on the display device when the driver performs a predetermined operation in response to the notification.

4. The vehicle of claim 1, wherein the controller is configured to perform a process of parking the vehicle in a parking space of the vehicle washer by automatic driving while displaying the image on the display device.

5. The vehicle of claim 1, further comprising:
a window that is openable; and
a door mirror that is foldable,
wherein the controller is configured to perform a process of closing the window and folding the door mirror when the receiver receives the signal.
